(19) United States
(12) Patent Application Publication
(10) Pub. No.: US 2009/0321153 A1
(43) Pub. Date: Dec. 31, 2009

(54) Drive train for a motor vehicle and method of operating a drive train of a motor vehicle

(76) Inventors: Elmar Boeckenhoff, Sturtgard (DE); Dieter Reckels, Portland, OR (US)

Correspondence Address: KLAUS J. BACH, 4407 TWIN OAKS DRIVE, MURRYSVILLE, PA, 15668, US

(21) Appl. No.: 12/220,692

(22) Filed: Jul. 25, 2008

(30) Foreign Application Priority Data
Jun. 27, 2008 (DE) 10 2008 030581.2

(51) Int. Cl. B62D 61/10; B60K 5/08

(52) U.S. Cl. 180/24.1; 477/2

(57) ABSTRACT

In a drive train for a motor vehicle having at least first and second drive axles each provided with two drive wheels for moving the motor vehicle, wherein the drive train comprises a first drive unit connected to the first drive axle and a second drive unit connected to the second drive unit for driving the wheels of the drive axles or, respectively, being driven thereby, the wheels of the first and second drive axles are operable independently of each other and clutch elements are arranged in the drive train between the wheels of the second axle and the second drive unit for mechanically disconnecting the second drive unit and the wheels of the second drive axle.

### BACKGROUND OF THE INVENTION

The invention relates to a drive train for a motor vehicle, particularly a commercial vehicle, with at least three axles of which each has at least two wheels and with first and second drive units and to a method of operating the drive train.

In motor vehicles, in addition to the internal combustion engine, a further drive unit may be provided for assisting the internal combustion engine under heavy load conditions and also for reducing the fuel consumption which positively affects the vehicle emission of pollutants. Various drive concepts are known for such drive arrangements as, for example, serial or parallel hybrid vehicles. The use of such concepts however is mainly limited to passenger cars. Those concepts are generally not used in connection with commercial vehicles as these vehicles have much greater power requirements which cannot be satisfied by alternative drives.

There are however busses with hybrid drive systems which are mainly operated by electric drive units and additionally include an internal combustion engine to be driven thereby when necessary. DE 35 22 062 C2 discloses such a system for an articulated bus. The bus is powered by an electric motor which is supplied with electric current by an overhead electric power supply line. When no overhead power supply line is available, the bus can be driven by an internal combustion engine. The two axle drives of the respective driven axles, of which one is driven by the internal combustion engine and the other is driven by the electric motor, are interconnected by a Cardan shaft and, consequently, are mechanically interconnected. As a result, both axles are always driven at the same time, either by the electric motor or by the internal combustion engine or by both in combination. Such an arrangement however has the disadvantage that the respective operational drive unit has to drag along the other drive unit or axle drive which results in increased energy consumption.

It is the object of the present invention to provide a drive train for a motor vehicle, particularly a commercial vehicle, and a method of operating such a drive unit wherein greater fuel savings are achieved than can be obtained in connection with the known systems.

### SUMMARY OF THE INVENTION

In a drive train for a motor vehicle having at least first and second drive axles each provided with two drive wheels for moving the motor vehicle, wherein the drive train comprises a first drive unit connected to the first drive axle and a second drive unit connected to the second drive unit for driving the wheels of the drive axles or, respectively, being driven thereby, the wheels of the first and second drive axles are operable independently of each other and clutch elements are arranged in the drive train between the wheels of the second axle and the second drive unit for mechanically disconnecting the second drive unit and the wheels of the second drive axle.

In this arrangement, it is decided, dependent on operating conditions of the motor vehicle, when the electric motor and/or the generator are to be used as motors or generators. The electric motor and the generator are so controlled that the internal combustion engine is operating under optimum conditions as far as specific fuel consumption is concerned, that is, where the operation is most efficient. With this arrangement, fuel consumption and, consequently, emissions of pollutants can be reduced.

It is particularly advantageous if clutch elements are provided for the second driven axle preferably comprising two partial elements, each being arranged close to a vehicle wheel, in order to prevent that the second drive unit is connected to the wheels of the axle and the wheels are mechanically connected to a large part of the drive train and the differential gear unit of the axle and have to drag them along which would result in a lower operating efficiency. This is particularly advantageous with respect to large commercial vehicles whose components are subjected to greater loads and stresses and which therefore are larger and heavier.

Alternatively, it may be advantageous if the clutch element is arranged between second drive unit and the differential axial gear of the second drive axle. Then the wheels and the drive unit can be separated from one another by a single clutch element. The advantage of such an arrangement resides in a more simple design which is more expedient in connection with small utility vehicles.

It is particularly advantageous if both embodiments of the clutch elements are used. Then the second drive axle can be disconnected from the wheels and also from the second drive unit which provides for advantages concerning the load of the second drive axle, the axle differential gear of the second drive axle and the second drive unit. The second drive axle and its differential gear are then not subjected to moments and effects caused by the drive units. The second drive unit can then be fully separated from the wheels and from the axle differential unit which reduces wear of the second drive unit. Of the advantages mentioned above, the arrangement with clutch elements disposed closely to the wheels and a clutch element ahead of the second axle differential gear is considered to be particularly advantageous.

In an advantageous embodiment of the invention, the second drive unit is an electric motor which can also be operated as a generator. This motor/generator can be use for driving the second drive axle or for converting mechanical energy of the motor vehicle into electric energy for supplying other electrical components or for storing the electrical energy for example in a battery.

It is particularly advantageous if a third drive unit is connected to the first drive axle in addition to the internal combustion engine. In this way, better assistance can be provided to the internal combustion engine for even lower fuel consumption of the internal combustion engine. This is expedient in particular in connection with larger motor vehicles, particularly commercial vehicle, but substantial fuel savings can be achieved even in connection with small motor vehicles.

The third drive unit is preferably also an electric motor which can also be operated as a generator. Like the electric motor used as the second drive unit, this motor is used for driving an axle, in this case, the first drive axle and, additionally, can convert mechanical energy into electric energy for storing in a battery or for directly driving other electrical components of the motor vehicle.

Another separation element may be provided for clutch the third drive unit from the first drive axle. It is particularly advantageous, if the second clutch element for the first drive axle comprises two partial elements, which are each arranged close to a wheel in order to permit selective connection of the third drive unit to the wheels of the first axle and the differential axle gear unit, so that the operating efficiency can be improved when the third drive unit is not in operation. This is particularly advantageous in connection with relatively large commercial vehicles whose components are subjected to larger loads and stresses and therefore are larger and heavier.

Alternatively, the second separation element may be arranged between the third drive unit and the differential axle gear of the first drive axle. Then the wheels may be separated by only one separation element. The advantage of this arrangement resides in the simple construction which is preferably used in connection with relatively small commercial vehicles. This arrangement makes it also possible for the internal combustion engine to drive the third drive unit without the transmission of any torque to the rest of the drive train.

It is particularly advantageous to use both embodiments of the second separation element. Then the first drive axle can be separated from the wheels and also from the first and/or the second drive unit. This has advantages with respect to the load of the first drive axle, the axle differential gear of the first drive axle and the first and third drive unit. The first drive axle and the differential gear of this axle are therefore not subjected to any moment and influences by the drive units. The first and/or third drive units are fully separated from the wheels and the axle differential gear which reduces use of the third drive unit. Of the arrangements mentioned, the variant including the two embodiments of the second separation element is particularly advantageous.

In a method according to the invention for operating a drive train for a motor vehicle, particularly a commercial vehicle, with a first axle driven by an internal combustion engine and a second axle driven by a second drive unit wherein the wheels of the first and the second drive axles have no mechanical drive connection and wherein between the wheels of the second drive axle and the second drive unit a first clutch element is arranged by which the wheels of the second drive axle and the second drive axle are mechanically separated, the first drive axle is driven by the first drive unit which is an internal combustion engine and the second drive axle is driven by the second drive unit, when large drive torques are needed at the wheels. With this method, the internal combustion engine is assisted when this is necessary. During normal operation, the internal combustion engine can generally be assisted by the second drive unit in order to minimize fuel consumption and emissions of pollutants. Furthermore, with this method, the internal combustion engine can be operated at a constant power output while excess power requirements can be satisfied by the second drive unit.

A special case is the startup of a motor vehicle wherein, with the method according to the invention, the power requirements of the internal combustion engine are reduced and favorable fuel consumption values are obtained.

It is particularly advantageous to provide, in addition to the first and second drive units, a third drive unit connected to the first drive axle for assisting the first and the second drive unit in accommodating large torque requirements.

The invention and further advantages thereof will become more readily apparent from the following description of particular embodiments thereof on the basis of the accompanying drawings.

### BRIEF DESCRIPTION OF THE DRAWINGS

FIG. 1 shows a first embodiment of the invention showing schematically a drive train for a tractor,

FIG. 2 shows a second embodiment of the invention showing schematically a drive train for a tractor, and

FIG. 3 shows a third embodiment of the invention showing schematically a drive train for a tractor.

### DESCRIPTION OF THE VARIOUS EMBODIMENTS

Below, three embodiments will be described in detail. However, the invention is not limited to the shown embodiments and the corresponding methods described therefore.

In the description only parts of the drive train are described in detail as the general tractor configuration as shown schematically is conventional. The drawings also show only the components which are necessary for the description of the arrangement and the method of a drive train according to the invention.

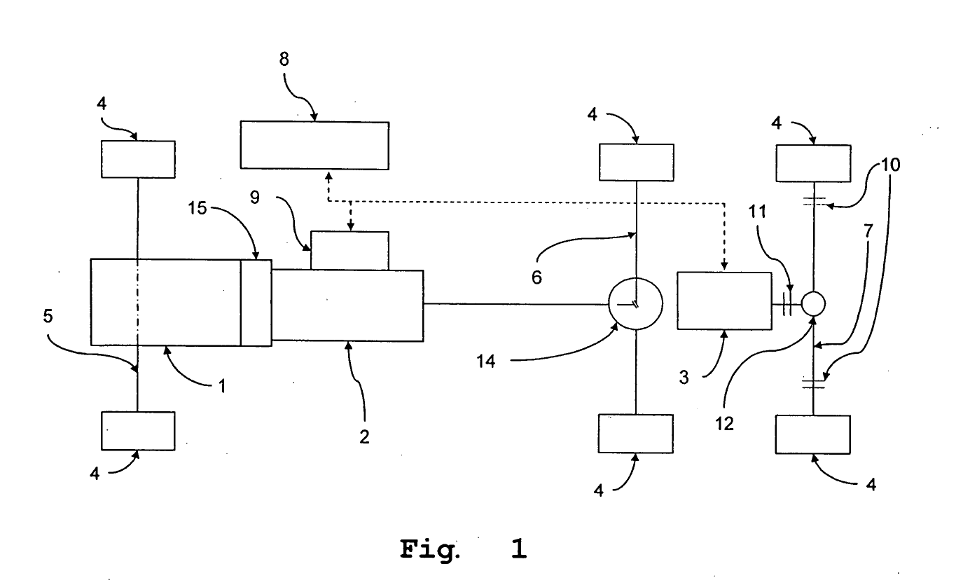

FIG. 1 shows schematically a drive train for a tractor which includes an internal combustion engine 1, preferably a Diesel engine provided with a starter element 15 and a transmission 2. The figures show for the tractor a front axle 5, which is not a drive axle but, preferably, only a steering axle, a first drive axle 6, a second drive axle 7 and wheels 4 on all the axles 5, 6, and 7. The first drive axle 6 includes an axle differential gear 14 and the second drive axle 7 includes an axle differential gear 12 to which an electric motor/generator 3 is connected for driving the axle 7 or, respectively, to be driven thereby. The engine-transmission unit 1, 2 is also provided with an electric generator 9 for supplying charging current to a battery 8. The electric generator 9 however may also be used as an electric motor for increasing the output torque of the engine/transmission unit 1, 2. The second drive axle 7 includes a first clutch element comprising two partial elements 10 which are arranged close to the wheels for uncoupling the wheels from the drive train and/or a further clutch element 11 which is arranged between the electric motor 3 and the axle differential gear 12 of the second drive axle 7 for uncoupling the second drive axle 7 from the electric motor/generator 3. Below, the first clutch element will be referred to either as wheel clutch elements 10 or as axle clutch element 11. The designation may refer either to the first wheel clutch element 10 or the second axle clutch element 11, as only one of the clutch element 10, 11 is required for the intended operation. However, it is noted that both clutch elements 10, 11 may be installed in the drive train of a vehicle.

The wheels 4 of the first drive train 6 and the wheels 4 of the second drive axle are not drive-connected and consequently can be driven independently from one another. In this way, it is prevented that either of the respective drive units needs to drive the other.

In the shown embodiment of the invention, the tractor has three axles 5, 6, and 7, wherein the first axle 5 is not a drive axle but a steering axle. The steering axle 5 is arranged in the normal driving direction at the front end of the tractor and the two drive axles, or possibly driven axles 6 and 7 are arranged at the rear of the tractor as shown in FIG. 1. All the axles 5, 6, 7 include wheels 4; the wheels 4 of the drive axles 6, 7 are drive wheels. The first drive axle 6 is connected to the internal combustion engine 1, which is preferably a Diesel engine, via the transmission 2 and the axle differential gear 14 for transmitting a torque between the engine and the axle wheels.

Between the internal combustion engine 1 and the transmission 2, the starter element 15 is arranged. The second drive axle 7 is connected via the axle differential gear 12 of the second drive axle 7 to the electric motor 3 which can be used also as a generator. Between the axle differential gear 12 of the second drive axle 7 and the electric motor 3, the second separation element 11 is arranged just ahead of the axle differential gear. In addition, it is again pointed out that there is no direct connection between the drive wheels 4 of the drive axles so that the internal combustion engine wheel drive and the electric motor wheel drive arrangements are mechanically fully separated. The electric motor/generator 3 is electrically connected to the battery 8 and the generator 9 which may also be used as an electric motor. The motor/generator 9 is in this embodiment mechanically coupled to the transmission 2. Herein, the generator 9 may be integrated into the transmission 2. The electric connection between the motor/generator 9, the battery 8 and the electric motor/generator 3 permits a current flow in any direction, that is, the generator 9 and the electric motor 3 can supply charging current to the battery 8 or the battery 8 can supply current to either or both of the electric motor/generator 3 and the motor/generator 9 or current may be supplied from the motor/generator 9 directly to the electric motor/generator 3.

In this arrangement, the internal combustion engine 1 can be assisted by the electric motor 3 in driving the tractor when high tractor pulling forces are required in order to keep the power requirements for the internal combustion engine 1 at a lower level in order to lower the specific fuel consumption of the engine and its emissions. With the selective motor- or generator operation of the electric motor/generator 3, the internal combustion engine 1 can be operated at an essentially constant power level selected so as to be in an optimum fuel consumption range. The large fuel consumption differences caused by various operating conditions can be substantially reduced which results in lower fuel consumption and lower emissions of the engine. Depending on the vehicle operating conditions, it is decided whether the electric motor/generator 3 and/or the electric motor/generator 9 are operated as motors or as generators. The electric motor/generator 3 and/or the motor/generator 9 are so controlled that the internal combustion engine 1 remains as much as possible in an optimum operating range with respect to fuel consumption and emissions that is at a most efficient power level.

The first clutch elements 10 and 11 can be activated when needed in order to interrupt the drive train via the second axle 7 or to end a generator braking operation of the electric motor/generator 3 for example when the battery no longer is to be charged or a generative braking operation is no longer needed or desired.

When the electric motor/generator 3 is operated as a drive motor, it assists the internal combustion engine 1 in driving the tractor.

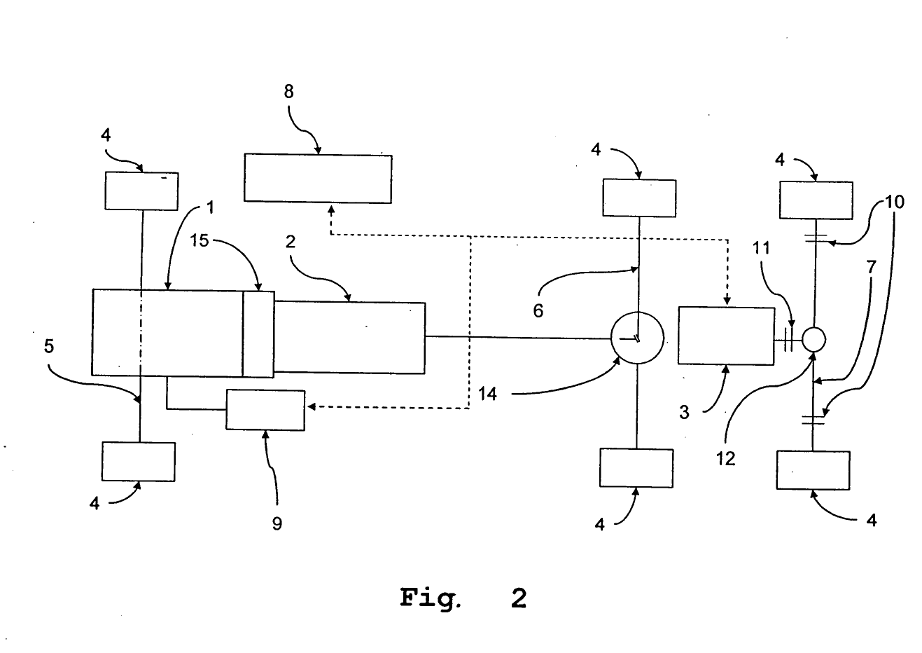

FIG. 2 shows a second drive train arrangement according to the invention for a tractor. It includes an internal combustion engine 1 preferably in the form of a Diesel engine, a starter 15, a transmission 2, a steering axle 5, a first drive axle 6 and a second drive axle 7 and wheels 4 mounted on all the axles 5, 6, 7. The first drive axle 6 is provided with an axle differential gear 14 and the second drive axle 7 is provided with an axle differential gear 12. An electric motor/generator 3 is mechanically connected to the second drive axle 7 and is electrically connected to a battery 8. A generator/motor 9 is connected to the internal combustion engine 1. Clutch elements 10 are provided on the drive axle 7 close to the wheels 4 and/or a clutch element 11 is provided between the electric motor/generator 3 and the axle differential gear 12 of the second drive axle 7.

In this arrangement, the generator/motor 9 can be used as a third drive unit, which is arranged either at the engine input or the engine output end and which is mechanically, operatively connected to the first drive axle 6. The generator/motor 9 may also be operated basically as a motor or a generator that is, as energy supplier for the electric motor 3 or for charging the battery 8. The electrical connection of the electric motor/generator 3, the generator/motor 9 and the battery 8 is as described in connection with FIG. 1, but is possible also in other forms.

The method of operating the drive train as described in connection with FIG. 1 also applies to the drive train shown in FIG. 2.

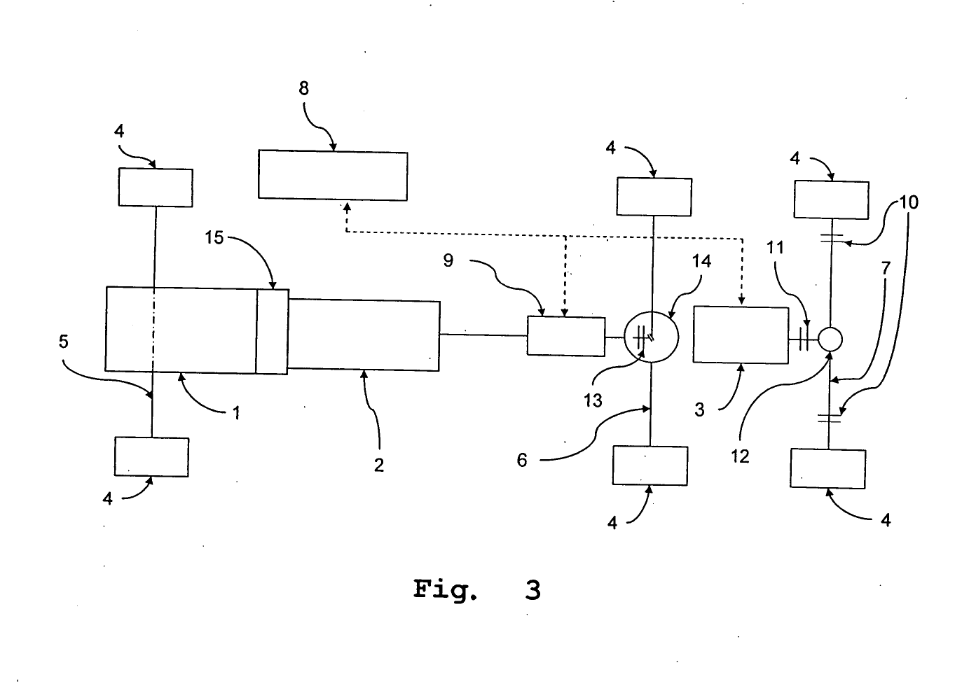

FIG. 3 shows a third embodiment of the drive train according to the invention for a tractor. This arrangement, in addition to the internal combustion engine 1, which is preferably a Diesel engine, includes a starter element 15, a transmission 2, a front steering axle 5, a first drive axle 6, a second drive axle 7, wheels 4 arranged at the axles 5, 6, 7, an axle differential gear 14 for the first drive axle 6 and an axle differential gear 12 for the second drive axle 7, an electric motor/generator 3, a battery 8, a generator/motor 9, a clutch element 10 comprising two partial elements arranged close to the wheels and/or a clutch element 11 arranged between the electric motor 3 and the axle differential gear 12 of the second drive axle 7. Another clutch element 13 is arranged in the embodiment of FIG. 3 between the axle differential gear 14 of the first drive axle 6 and the generator/motor 9, which in this embodiment, is arranged in the drive train between the transmission 2 and the first drive axle 6. It is noted however that instead of providing the clutch element 13 between the generator/motor 9, two clutch elements could be provided adjacent the wheels of the first drive axle 6 as it is shown for the second drive axle 7. Furthermore, the generator/motor 9 may be drive-connected to a drive shaft extending between the transmission 2 and the first drive axle differential 14 by a belt drive and to arrange the clutch element 13 in such a way that it separates the belt drive from the generator/motor 9 or from the drive shaft.

The arrangement of the drive shaft as shown in FIG. 3 shows that the generator/motor 9 is mechanically directly coupled to the first drive axle 6. The generator/motor 9 is arranged between the transmission 2 and the axle differential gear 14 of the first drive axle 6. In this way, the generator/motor 9 can be used as third drive unit. By the additional clutch element 13, the generator/motor can be separated from the first drive axle 6. When the generator/motor 9 is separated from the first drive axle 6, it can still be operated by the internal combustion engine 1 to generate electric energy for charging the battery 8 or to supply electric energy to the electric motor 3 for driving the wheels of the second drive axle 7.

The drive train of FIG. 3 can be operated with the same method as described in connection with FIGS. 1 and 2. Herein, the third drive unit provides for a further drive means by the selective addition of the electric motor/generator 3 and the generator/motor 9 so that the power assistance for internal combustion engine can be further improved.

Basically, the internal combustion engine can be of any type. Also, the second and third drive units are not limited to electric motor/generators, but may comprise any other form of drive unit such as hydraulic or pneumatic drives. It is also possible to use the second and third drive units as braking devices and to use, instead of a generator/motor 9, a pressure storage device if one of the other drive units is a hydraulic or pneumatic drive.

It is noted that with the arrangement of the present invention, the tractor can be operated only by the electric motor 3 or by the electric motor/generator 3 and the generator/motor 9 or other drive units for example when approaching a loading ramp or for short distances for example in traffic jams or in city traffic situations.

The invention is furthermore not limited only to commercial vehicles, but can be used in connection with any type of motor vehicle.

What is claimed is:

1. A drive train for a motor vehicle having at least three axles (5, 6, 7) with at least first and second drive axles (6, 7), said drive train comprising: a first drive unit (1) connected to said first drive axle (6) and a second drive unit (3) connected to said second drive axle (7) for driving the,wheels (4) of said drive axles (6, 7) or, respectively, being driven thereby, the wheels of said first drive axle (6) and the wheels of said second drive axle (7) being operable independently of each other without any mechanical connection therebetween and at least one clutch element (10, 11) arranged in the drive train between the wheels (4) of the second drive axle (7).

2. The drive train according to claim 1, wherein the at least one clutch element (10) comprises two partial elements arranged each on the second drive axle (7) in close proximity to the wheels (4) of the first drive axle for operatively separating the wheels from the second drive axle so that they are rotatable in a dray-free manner.

3. The drive train according to claim 1, wherein the at least one clutch element (11) is arranged between the second drive unit and the second drive axle (7) for selectively disconnecting the second drive unit from the second drive axle (7).

4. The drive train according to claim 1, wherein the second drive unit (3) is a motor generator which is operable as a motor for driving the wheels of the second drive axle (7) or selectively as an electric generator being driven by the drive wheels (4) of the second drive axle (7) for retarding the motor vehicle while generating electric energy.

5. The drive train according to claim 1, wherein the first drive unit (1) is an internal combustion engine and another clutch element (13) is provided in the drive train between the internal combustion engine (1) and the first drive axle (6) for uncoupling the internal combustion engine (1) and the first drive axle (6) from each other.

6. The drive train according to claim 5, wherein a third drive unit (9) is provided which can be coupled mechanically to the first drive axle (6).

7. The drive train according to claim 6, wherein a battery (8) is provided and the third drive unit (9) is an electric motor/generator which when energized assists the first drive unit in driving the vehicle while the other clutch element (13) is closed or which is operable by the internal combustion engine for generating electric energy for charging the battery (8).

8. The drive train according to claim 1, wherein the first drive unit includes an internal combustion engine (1), a starter element (15) and a transmission (2) with a drive shaft for transmitting the engine torque to the first drive axle (6).

9. A method of operating a drive train of a motor vehicle having at least three axles (5, 6, 7) with at least first and second drive axles (6, 7), said drive train comprising a first drive unit (1) connected to said first drive axle (6) and a second drive unit (3) connected to said second drive axle (7) for driving the wheels (4) of said drive axles (6, 7) or, respectively, being driven thereby, the wheels (4) of said first drive axle (6) and the wheels of said second drive axle (7) being operable independently of each other without any mechanical connection therebetween and at least one clutch element (10, 11) arranged in the drive train between the wheels (4) of the second drive axle (7), said method including the step of driving the wheels of the first drive axle (6) by the first drive unit (1) and driving the wheels of the second drive axle (7) by the second drive unit (3) whenever large traction forces are needed.

10. A method of operating a drive train according to claim 9, wherein during startup of the motor vehicle the first drive axle (6) is driven by the first drive unit (1) and, at the same time, the second drive axle (7) is driven by the second drive unit (3).

11. A method of operating a drive train according to claim 9, wherein the second drive unit (3) drives the second drive axle (7) and a third drive unit (9) drives the first drive axle (6) which is also driven by the first drive unit (1) when large start-out traction forces are required.
